(19) United States
(12) Patent Application Publication
(10) Pub. No.: US 2022/0266274 A1
(43) Pub. Date: Aug. 25, 2022

(54) AN IMPROVED ASPIRATING SPRAY NOZZLE

(71) Applicant: Spray Nozzle Engineering Pty. Ltd., Mentone, Victoria (AU)

(72) Inventor: Sean MORGAN, Mentone, Victoria (AU)

(21) Appl. No.: 17/627,352

(22) PCT Filed: Jul. 17, 2020
(86) PCT No.: PCT/AU2020/000071

§ 371 Date: Jan. 14, 2022

(30) Foreign Application Priority Data
Jul. 17, 2019 (AU) 2019902515
Mar. 19, 2020 (AU) 2020900846

(51) Int. Cl. B05B 7/00; B05B 7/04; B05B 7/10; B05B 1/34; B05B 15/65; A62C 31/12; A62C 3/07

(52) U.S. Cl. CPC B05B 7/0068; B05B 7/0425; B05B 7/10; B05B 1/3405; B05B 15/65; A62C 31/12; A62C 3/07

(57) ABSTRACT

An aspirating spray nozzle including a cylindrical nozzle body, an integrated annular shroud and a nozzle cap. The cylindrical nozzle body has an externally threaded first end portion defining an inlet, a second end portion defining an outlet, and a middle portion. The integrated annular shroud encircles part of the nozzle body and has a base which is integrally joined to the middle portion by way of webbing means. The nozzle cap is adapted to be connected to the second end portion of the nozzle body.

### TECHNICAL FIELD

The present invention broadly relates to an aspirating spray nozzle. More particularly, the present invention relates to an aspirating spray nozzle with an integrated shroud.

### BACKGROUND OF THE INVENTION

Conventional aspirating nozzles used in fire protection systems, particularly for vehicle fire protection in the mining, forestry, waste management and transportation industries, typically include a nozzle body being fastened to a shroud. It has however been found that during the normal course of duty in environments that are gritty, greasy, hot and vibration prone, the severe vibration causes the joined nozzle body and shroud to come loose. As a result of the loosening, the nozzle body and the shroud would naturally rub against one another. These nozzles therefore have a shortcoming that they are very prone to abrasive wear over time. Also, these aspirating nozzles are commonly used in tight and difficult to reach engine bays on mining trucks and the like (as opposed to roof mounted sprinkler systems in building for example). Hence there is a need for these nozzles to be as compact as possible and easy to install and remove.

It is commonplace for aspirating nozzles to generate a high velocity solid stream and include wrench flats at a threaded portion adjacent to the aspirator inlet. Also, these aspirating nozzles also typically include spokes that are diametrically opposed. The function of such aspirating nozzles is generally based on the Venturi effect. In this connection, there is a need to improve the overall aerodynamics of these aspirating nozzles so as to maximize airflow through the shroud. In addition to the above, foams are a particularly useful agents used in firefighting. Firefighting foam acts to suppress a fire by cooling and enveloping the fuel source and starving it of oxygen, resulting in suppression of the combustion. Foam is typically produced by using a surfactant that interacts to break the surface tension of a water carrier, which in turn allows air to more easily mix with the water and create bubbles within the liquid. These bubbles congregate in the water thereby developing the suppression foam. Various mechanical means exist to assist various levels of foam expansions. They are classed from non-aspirating through to aspirating and are typically referred to as ‘Low Expansion’, ‘Medium Expansion’ and ‘High Expansion’. High Expansion has the greatest mechanical aspirating intervention Via dedicated foam making equipment. The development and resulting composition of modern fire-fighting foams has seen them particularly effective in fighting liquid fuel fires, whereby the foam, being less dense than the liquid fuel (as opposed to denser water which can flow underneath a fuel fire doing little to suppress its combustion while causing potential fire spread), can effectively act to coat a pool of hydrocarbon fuel hazard with a foam layer which acts as a thermal and evaporation barrier to inhibit and eventually extinguish combustion. Since a popular variant of fire-fighting foam (known as Aqueous film forming foam (AFFF)) emerged, it had been found to be an extremely effective fire suppressant, in particular in applications where flammable liquid pool fires may be present. The development of AFFF has found extensive military and civil applications, particularly within the mining industry, where such applications extend to the engine bays of many types of fuel powered vehicles, particularly mining vehicles. The degree of efficacy offered by AFFF has been regarded as essential in saving life and property. The high effectiveness and rapid fire suppression characteristics of AFFF Foams can be historically attributed to the type of surfactants used to generate the foam, this being the developed use of fluorosurfactants, and in particular the fluorosurfactant group PFAS, with the most effective fire suppression foams of this group having contained the sub-types PFOS, PFOA. fluorosurfactants have seen wide use in other everyday products such as fabric-protection sprays, along with the manufacture of nonstick pots and pans. fluorosurfactants are chemicals categorised under the group (PFAS—Per and Poly fluoroalkyl substances). This group includes the effective foaming agents (PFOS—Perfluorooctanesulfonic acid) and (PFOA—perfluorooctanoic acid), amongst others. Despite the effectiveness of these products in saving life and property, a dilemma has arisen with the developing knowledge and evidence that the presence of fluorosurfactants, in particular PFOS & PFOA, in drinking water, is associated with diseases including cancer as a result of their release into outdoor environments. Since firefighting foams are typically applied in outdoor environments, they are seen as a major contributor to the release of fluorochemicals into drinking water. Firefighters are similarly at risk through the inhalation of spray mist and dust contaminated with such exposure to fluorosurfactants. There are on-going health risk studies regarding PFAS chemicals and it is now known that both PFOS and PFOA chemicals are very persistent in the environment and in the human body, which means that they do not break down easily and can accumulate over time. Consequently, the use of PFAS, including the sub groups PFOS and PFOA, have been subjected to extensive review in respect to their risk to health. There is a progressing restriction of these substances which include the most effective foaming agents, PFOS (which is also deemed the most dangerous) and PFOA. In some jurisdictions, a total restriction or banning of fluorosurfactants now exists, requiring the introduction of fluorine-free foaming surfactants, most of which are hydrocarbon-based. With the restrictions of the above described substances, there is an urgent need to meet fire suppression standards with new fluorine-free firefighting surfactants that are far from being as efficient as their AFFF fore bares in terms of foaming and suppression efficacy within existing Low Expansion systems which are now required to function with the newer hydrocarbon-based fire suppression foaming surfactants. In particular, there is a need for spray nozzles adapted for the use of foam in existing styles of Fixed VFSS (VFSS—Vehicle fire suppression systems), along with portable systems which were almost entirely reliant upon well performing yet now deemed hazardous, AFFF—Fluorinated surfactant foams. As previously mentioned, the engineering of these systems falls within the ‘Low Expansion’ foam category, where what can be regarded as a standard water nozzle was used to disperse foam, but where an opportunity now exists to re-engineer the nozzle alone to provide the additional aspiration assistance needed for adequate function over and above what is typically referred to as “non-aspirated” Low Expansion foaming application. This is all due to the inadequacy of new foam substitutes to perform well within existing systems and design parameters which could prove very costly and problematic to fully re-engineer or replace. Thus there is a need to provide an improved spray nozzle to mitigate the need to radically re-engineer such systems.

The object of the present invention is to provide an improved aspirating spray nozzle which may overcome or at least ameliorate the abovementioned shortcoming and/or meet the abovementioned needs, or which may at least provide a useful alternative.

### SUMMARY OF THE INVENTION

According to the present invention, there is provided an aspirating spray nozzle including:

a cylindrical nozzle body having an externally threaded first end portion defining an inlet, a second end portion defining an outlet, and a middle portion;
an integrated annular shroud encircling part of the nozzle body and having a base which is integrally joined to the middle portion by way of webbing means; and
a nozzle cap adapted to be connected to the second end portion of the nozzle body.

In a preferred embodiment, the base includes an exterior periphery so shaped and configured as to facilitate manual or tool based engagement with the exterior periphery for turning of the rotatable spray nozzle.

Preferably, the exterior periphery includes one or more flats which enable the shroud to be driven to rotate by a tool such as a wrench or spanner. Alternatively, the exterior periphery is a hex which gives a good granularity of angles for the tool to approach from.

Preferably, the webbing means include spokes, each spoke having one end integrally connected to the interior of the base of the shroud and an opposite end to the middle portion of the nozzle body. More preferably, the spokes are evenly spaced apart around the cylindrical middle portion. Even more preferably, a side wall of each spoke partially defines a vent being arc-shaped visible from a rear end of the spray nozzle. Most preferably, the side wall has a flat elongate middle section flanked by radiused ends which merge with the interior of the base of the shroud and an exterior of the middle portion of the nozzle body, respectively. In a preferred embodiment, three spokes are provided in between the base of the shroud and the middle portion of the nozzle body thereby creating three vents around the nozzle body. Conveniently, the vents are configured to maximise airflow into the shroud through the base. Preferably, each spoke is disposed slantingly with respect to a plane defined by the base of the shroud so as to maximise the aerodynamics thereby generating a maximised Venturi effect when in use. Even more preferably, each spoke has a cross section with a relatively narrow width and a relatively long axial length.

In a preferred embodiment, the shroud is substantially frustoconically-shaped having a tapering external wall.

The first externally threaded end portion may be threadably connected to a wall, a manifold, a pipe or any other fittings.

Alternatively, the shroud is substantially cylindrically-shaped.

Preferably, the shroud has a front end. Preferably, the front end includes teeth with a chosen depth. The teeth depth may vary. Alternatively, the front end of the shroud has no teeth.

### BRIEF DESCRIPTION OF THE DRAWINGS

The invention may be better understood from the following non-limiting description of the preferred embodiments, in which:

FIG. 1 is a perspective front view of an aspirating spray nozzle in accordance with a first preferred embodiment of the present invention;

FIG. 2 is a perspective rear view of the aspirating spray nozzle of FIG. 1;

FIG. 3 is a front view of the aspirating spray nozzle of FIG. 1;

FIG. 4 is an end view of the aspirating spray nozzle of FIG. 1;

FIG. 5 is a side view of the aspirating spray nozzle of FIG. 1;

FIG. 6 is a cross sectional view of the aspirating spray nozzle of FIG. 1;

FIG. 7 is a perspective view showing the cross section of the spray nozzle of FIG. 1;

FIG. 8 is a side view of the spray nozzle of FIG. 1 with part of the shroud cut out so as to illustrate the air and fluid flow paths through the shroud and nozzle body respectively;

FIG. 9a is a side view of an aspirating spray nozzle in accordance with another preferred embodiment of the present invention;

FIG. 9b is a front perspective view of the aspirating spray nozzle of FIG. 9a;

FIG. 9c is a rear perspective view of the aspirating spray nozzle of FIG. 9a;

FIG. 10a is a side view of an aspirating spray nozzle in accordance with a further preferred embodiment of the present invention;

FIG. 10b is a front perspective view of the aspirating spray nozzle of FIG. 10a;

FIG. 10c is a rear perspective view of the aspirating spray nozzle of FIG. 10a;

FIG. 11a is a side view of an aspirating spray nozzle in accordance with a yet further preferred embodiment of the present invention;

FIG. 11b is a front perspective view of the aspirating spray nozzle of FIG. 11a;

FIG. 11c is a rear perspective view of the aspirating spray nozzle of FIG. 11a;

FIG. 12a is a side view of an aspirating spray nozzle in accordance with a yet further preferred embodiment of the present invention;

FIG. 12b is a front perspective view of the aspirating spray nozzle of FIG. 12a; and

FIG. 12c is a rear perspective view of the aspirating spray nozzle of FIG. 12a;

### DETAILED DESCRIPTION OF THE DRAWINGS

It should be noted that the aspirating spray nozzle of the present invention is designed to function within the Low Expansion category referred to above. To this end, the spray nozzle of the present invention is designed to provide additional aspiration assistance over and above what is typically referred to as “non-aspirated” Low Expansion foaming application. It should also be noted that the aspirating spray nozzle 10 is designed to generate a full conical spray plume (as opposed to the conventional solid stream jet).

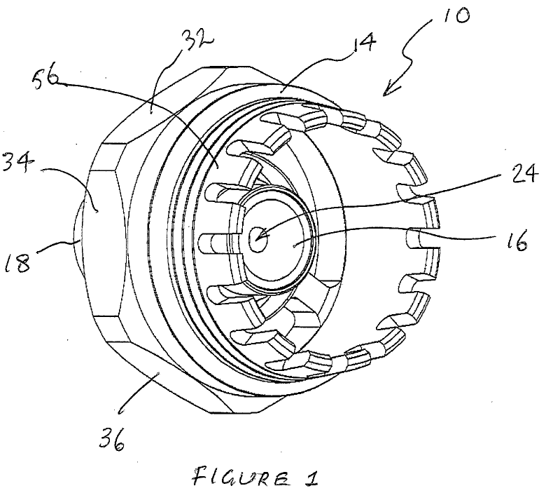

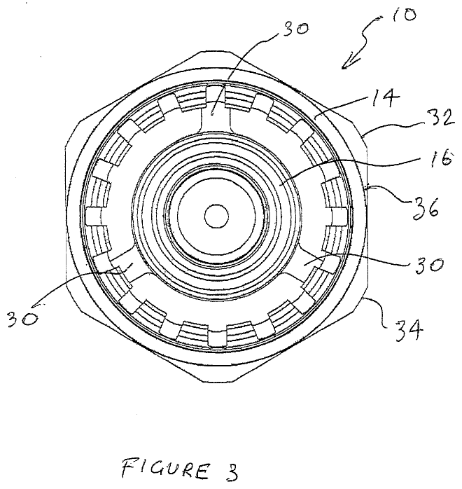

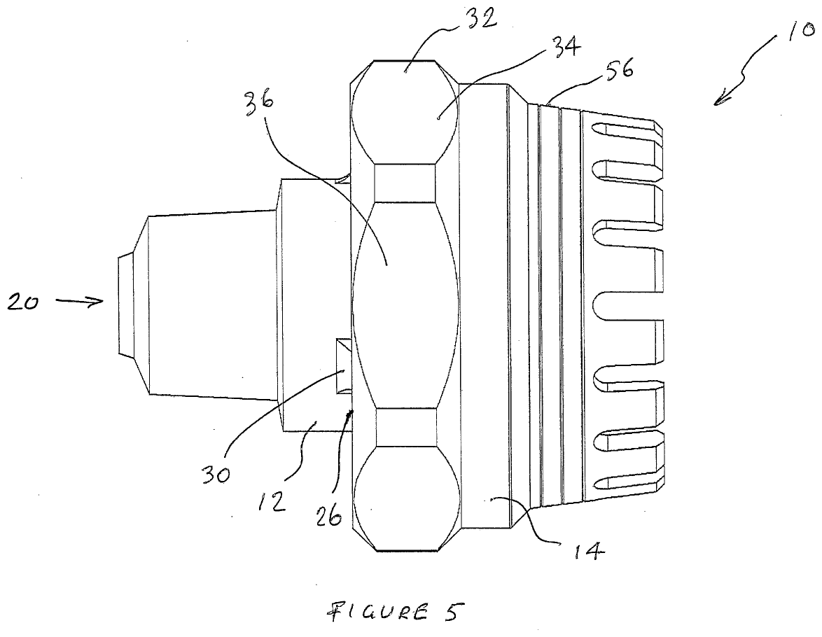

Referring to FIGS. 1 to 7, there is shown an aspirating spray nozzle 10 which has a cylindrical nozzle body 12, an annular shroud 14 which is integrated with the nozzle body 12, and a nozzle cap 16. The cylindrical nozzle body 12 has an externally threaded (first) end portion 18 (although the threads are not shown in any of the figures) defining an inlet 20, a second end portion 22 defining an outlet 24, and a middle portion 26. The end portion 18 is configured to facilitate threadable engagement of the aspirating spray nozzle 10 with a counterpart provided in a wall, a manifold, a pipe or any other fittings, as desired.

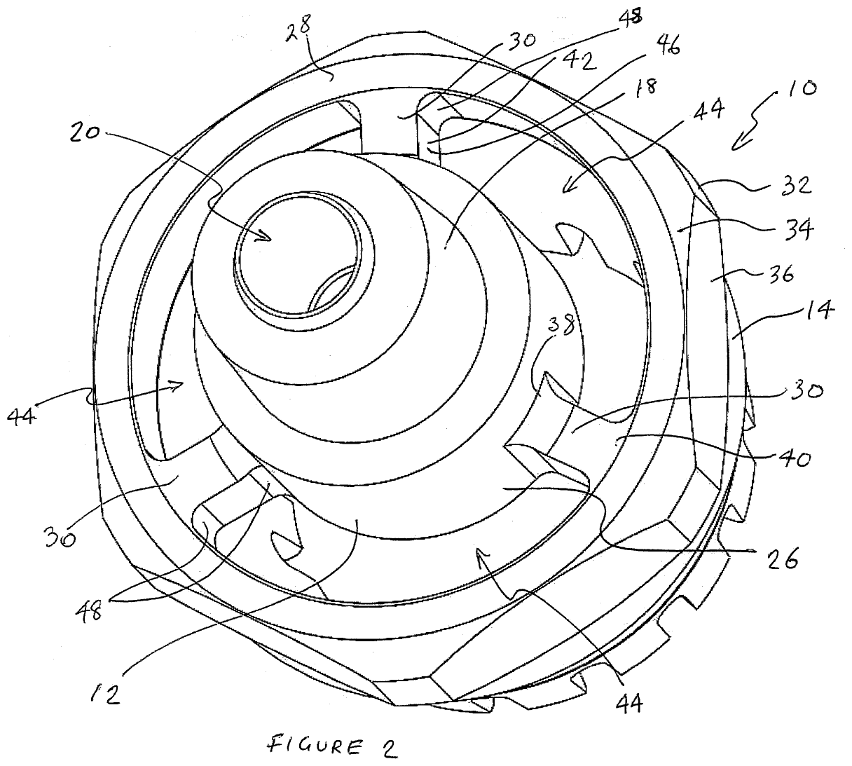

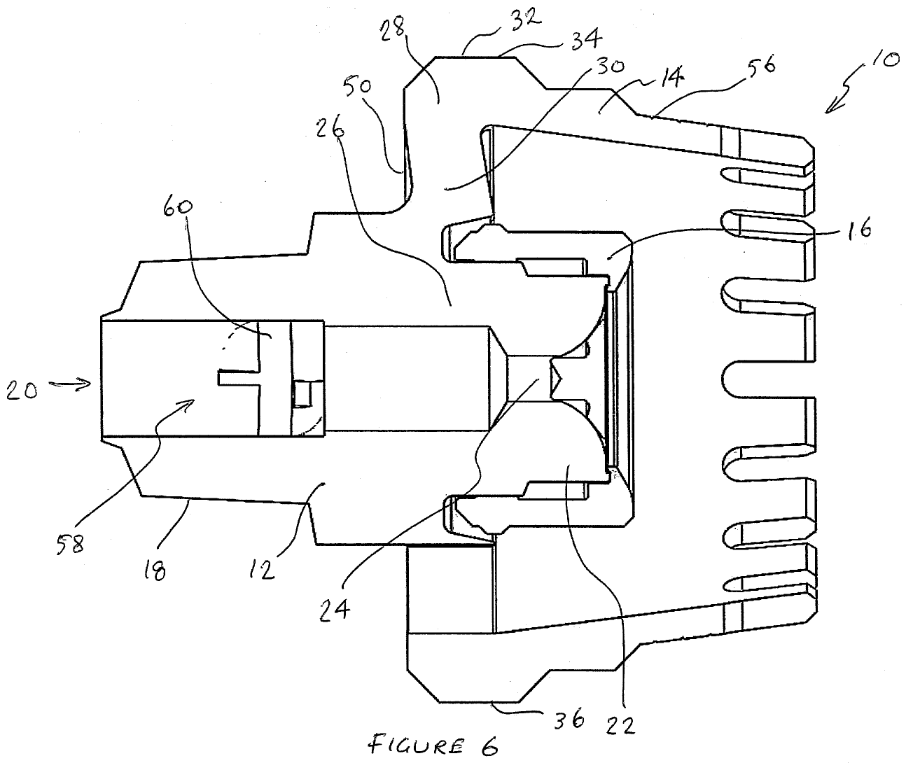

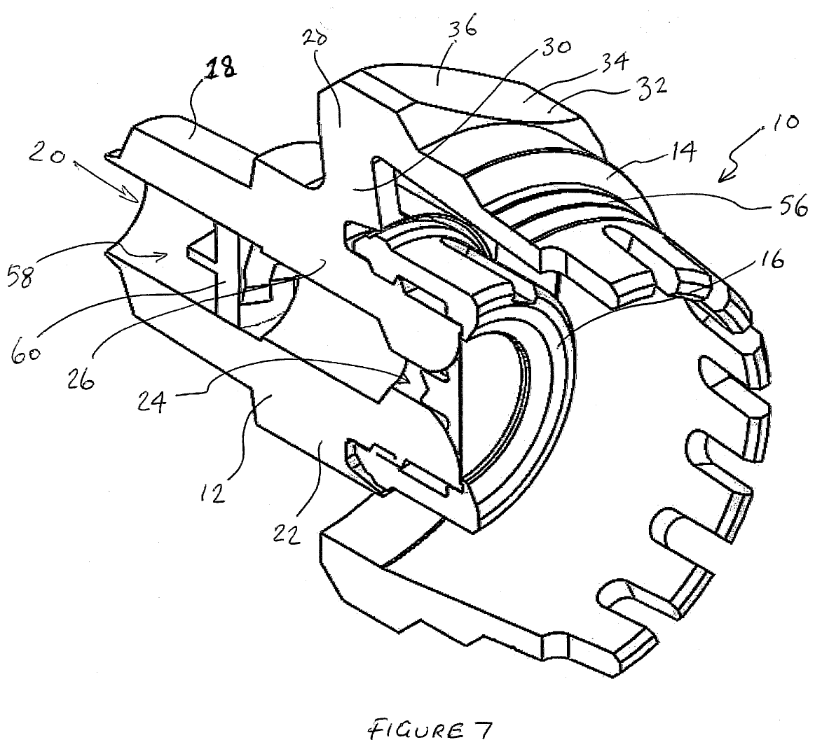

As best shown in FIGS. 6 and 7, the integrated annular shroud 14 is designed to encircle part of the nozzle body 12. As such, the nozzle cap 16 which includes the exit orifice are surrounded and encapsulated by the shroud 14. The shroud 14 has a base 28 which is integrally joined to the middle portion 26 of the nozzle body 12 by way of webbing means which in the present embodiment is in the form of three spokes (also see FIGS. 2 to 4). The nozzle cap 16 is adapted to be connected to the front (second) end portion 22 of the nozzle body 12. The base 28 of the shroud 14 includes an exterior periphery 32 so shaped and configured as to facilitate manual or tool based engagement with the exterior periphery for turning of the rotatable spray nozzle 10.

Referring to FIGS. 1 to 8, the exterior periphery 32 is a hex 34 which enables the shroud to be driven to rotate by a tool such as a wrench or spanner. The hexagonal shape is preferred as it gives a good granularity of angles for the tool to approach from. It should however be noted that the exterior periphery 32 only need to have one or more wrench flats 36 so as to allow firm gripping by the wrench or spanner in order to apply an adequate amount of rotational torque for tightening and loosening of the spray nozzle 12. The hex 34, being placed around the circumference of the base 28 which is the widest part of the shroud, allows easy and convenient frontal tool engagement for the purposes of attaching and removing the spray nozzle 10 to another object by way of a co-operative socket tool or spanner. Also, the location of the hex 34, being away from the vents 44 of the shroud 14, facilitates a smoother and lower diametric profile for unencumbered and optimised air flow through the vents 44. It also offers the advantage of allowing ease of manufacture. This is due to the fact that an aspirating spray nozzle cast or moulded can be more readily machined in a more economical fashion.

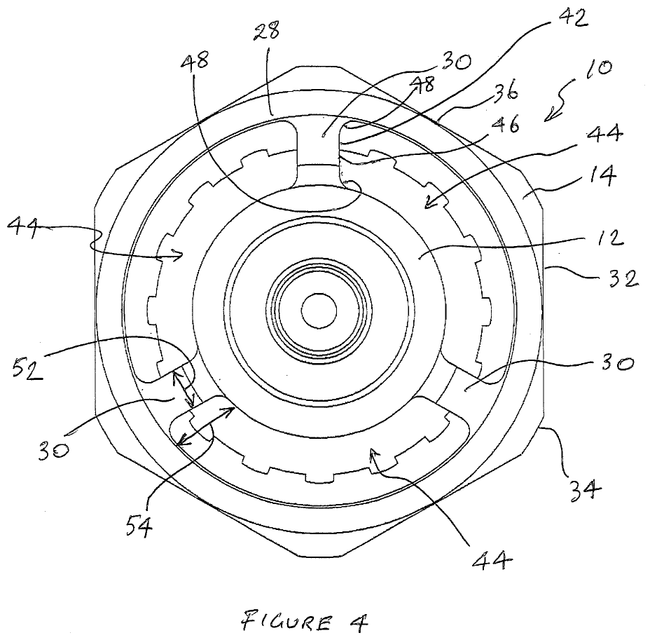

As best shown in FIGS. 2 and 4, each of the three spokes 30 has one end 40 integrally connected to the interior of the base 28 of the shroud 14 and an opposite end 38 to the middle portion 26 of the nozzle body 12. In the present embodiment, the three spokes 30 are evenly spaced apart around the cylindrical middle portion 26. A side wall 42 (for example) of each spoke 30 partially defines a vent 44 being arc-shaped visible from the rear end of the spray nozzle 10. The side wall 42 has a flat elongate middle section 46 flanked by radiused ends 48 which merge with the interior of the base 28 of the shroud 14 and an exterior of the middle portion 26 of the nozzle body 10, respectively. Three spokes 30 are provided in between the base 28 of the shroud and the middle portion 26 of the nozzle body 12 thereby creating three vents 44 around the nozzle body 10. The vents 44 are configured to maximise airflow into the shroud 14 through the base 28. Referring to FIG. 6, each spoke 30 is disposed slantingly with respect to a plane 50 defined by the base 28 of the shroud 14 so as to maximise the aerodynamics thereby generating a maximised Venturi effect when in use. As best shown in FIG. 4, each spoke 30 has a cross section with a moderate width 52 and a relatively long axial length 54. As such, the spokes possess adequate strength to be depended on to maintain the structural integrity of the spray nozzle 10 as a whole when a specified torque is applied thereto during attachment or removal of the nozzle 10. In essence, the spokes 30 between the radial inlet vents 44 have been specially designed to an optimum size such that the small radii in the kidney-shaped corners of the aspiration vents 44 are reduced in size whilst the thinnest possible radial section of the spokes 30 is achieved so as to enhance and maximize airflow. In order to maintain a high structural strength, the axial length of the spokes 30 is increased. It is important to note that the spokes 30 are also capable of enabling attachment of an optional blow off protection cap foil (not shown). As such, the spokes 30 are configured and positioned to collectively provide structural integrity when a specified torque is applied via the hex 34 for engagement or removal of the aspirating spray nozzle 10. It is also important to note that the described design of the spokes 30 enables the spray nozzle 10 to remain compact without compromising functionality.

Additionally, it will be appreciated that the relatively long axial length 54 aids in sucking in air for generation of the Venturi effect and contributes to making the desired flow laminar. Also, the relatively thick and long spokes 30 are designed to facilitate high strength whilst not impeding aspiration flow efficiency. In operation, there is a need for the aspirating spray nozzle 10 to be easily screwed on before use and screwed off for removal. The hex 34 provided on the outside of the shroud 14 allows an easily accessible tool such as a wrench or spanner to be applied to facilitate the aforementioned screwing on and off activities. In order to facilitate and sustain such activities driven by the tool, the structure and configuration of the connecting components, being the spokes 30, must facilitate a high torque transfer from the shroud 14 where the tool engagement occurs, through to the spokes 30. To this end, even though each of the spokes 30 has an adequate cross-sectional area, it relies more upon axial depth for strength rather than lateral width. This configuration enables maximised air flow efficiency between the spokes 30 by keeping the air flow restriction to a bare minimum. The prolonged length of the spokes 30 also facilitates air flow stabilisation and improve laminar flow into the aspirator. The geometry and distribution of the spokes 30 are also designed to ensure that the nozzle protection cap 16 can be accommodated with no impediment whilst still maintaining the overall compactness. It should also be noted that whilst maximising airflow, the spokes 30 are designed to complement attachment of an optional blow off protection cap foil (not shown).

It will be appreciated that the shroud 14 is substantially frustoconically-shaped having a tapering external wall 56. It is important to note that the nozzle body 12 is fully integrated with the shroud 14 (also commonly referred to as the aspirator) as one piece. Also, referring to FIGS. 6 and 7, the nozzle body 12 provides a passageway 58 which is adapted to receive a swirl vane 60 to generate and maintain a conical spray pattern.

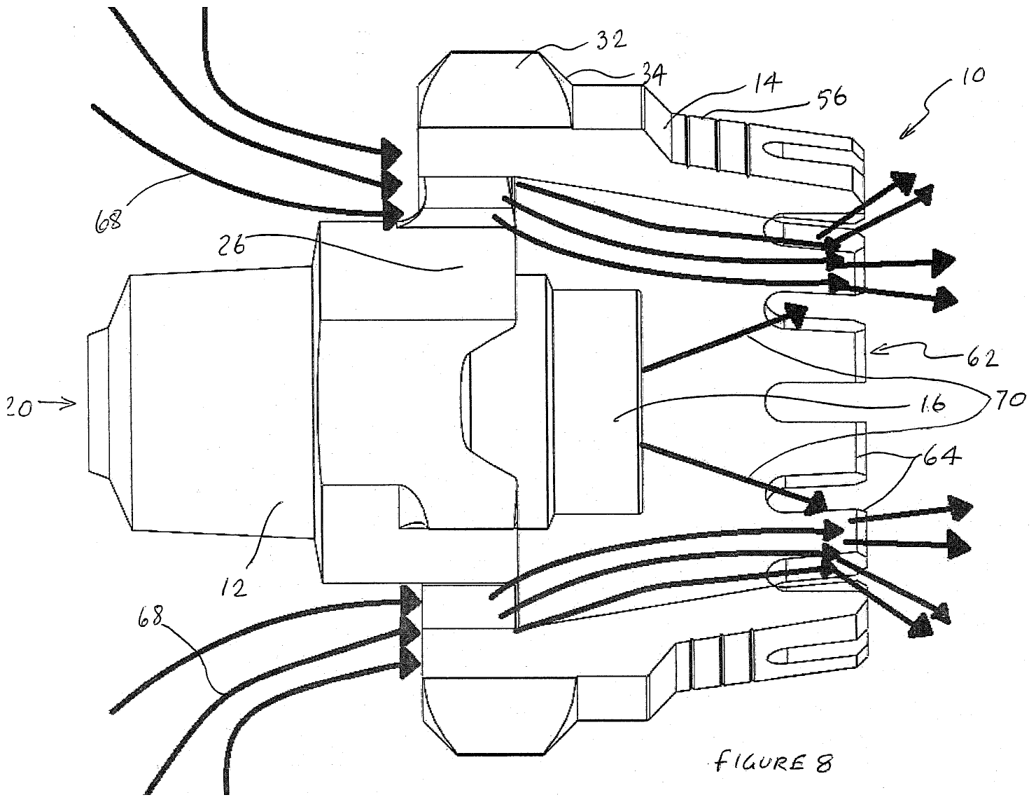

As shown in FIG. 8, the annular shroud 14 has a crown 62 with a plurality of agitation teeth 64 which function as aeration mix foaming enhancers. During operation, a full conical spray, being effected by the swirl vane 60, is emitted through the outlet 24 and aimed at the teeth 64. By way of the Venturi effect, air is vacuumed through the inlet 20 (indicated by arrows 68 in FIG. 8), mixed with the nozzle fluid coming out of the outlet 24 (indicated by arrows 70 in FIG. 8) and simultaneously agitated by the teeth 64 located at the crown 62 of the shroud 14. As such, the spray nozzle 10 is able to achieve effective aerating and distributing of surfactants which may act as detergents, wetting agents, emulsifiers, foaming agents, and dispersants.

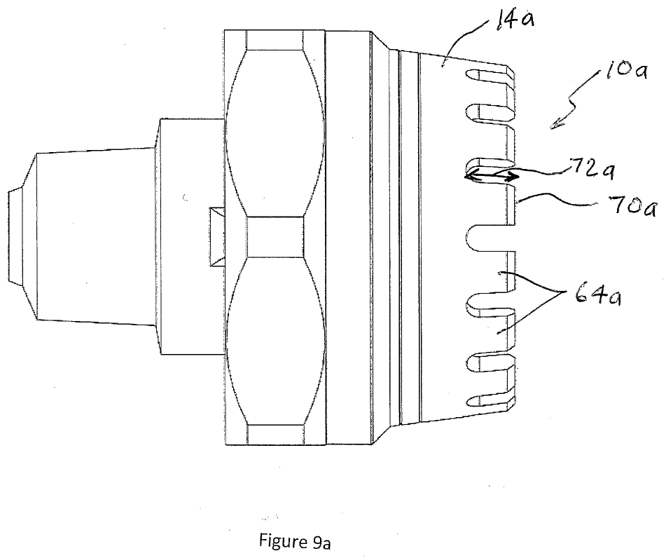

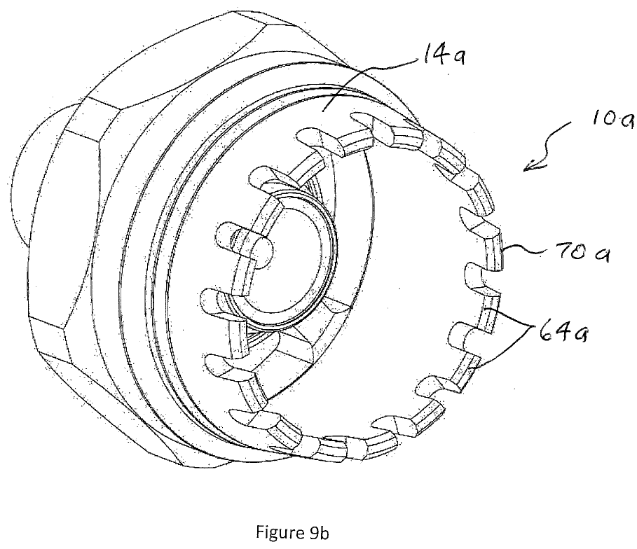

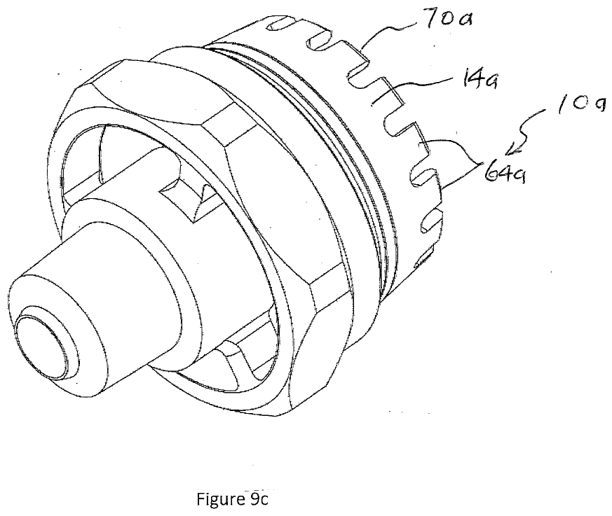

Referring to FIGS. 9a to 9c, in another embodiment, aspirating spray nozzle 10a has a shroud 14a with a front end 70a. The front end 70a has a plurality of teeth 64a, each of which having a depth 72a (see FIG. 9a). In this embodiment, the depth 72a is approximately 3.7 mm. The depth 72 however may vary effectively from approximately 2.5 mm to 5 mm (such as that depicted in the embodiment shown in FIG. 1) as desired.

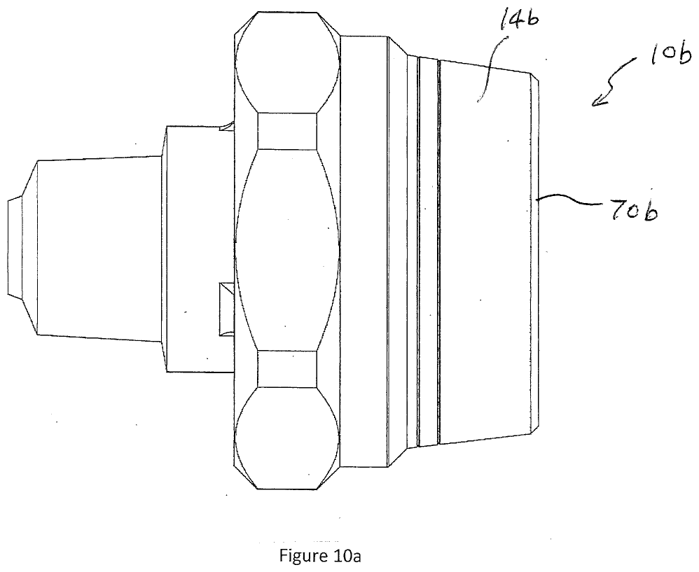

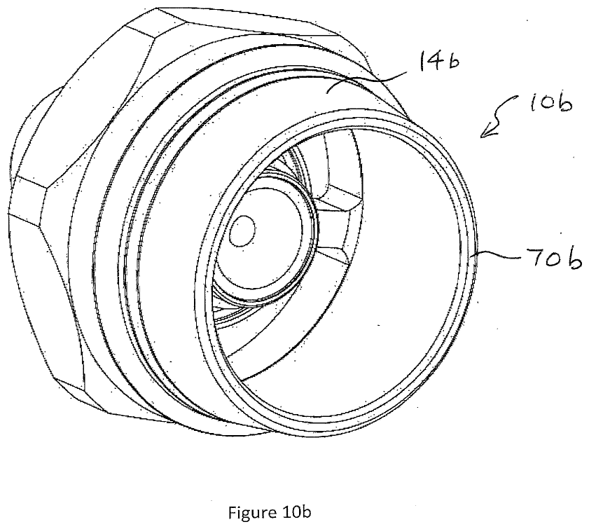

Turning now to FIGS. 10a to 10c, in a further embodiment, aspirating spray nozzle 10b has a front end 70b. In this embodiment, the front end 70b of the shroud 14b has no teeth.

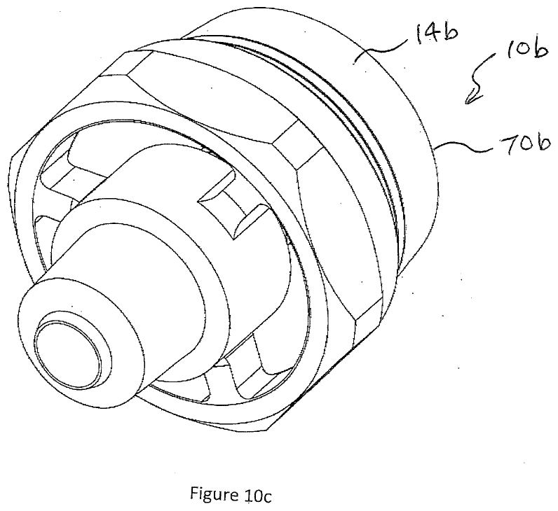

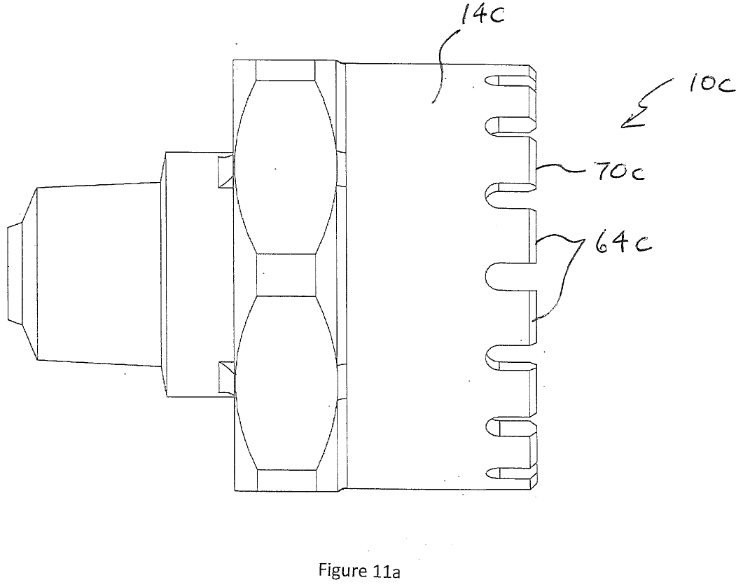

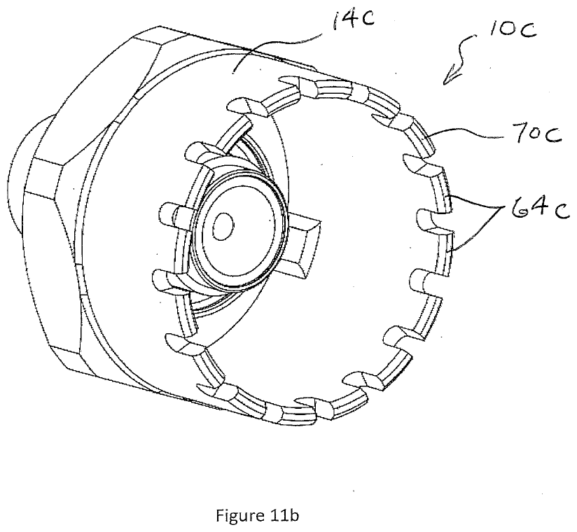

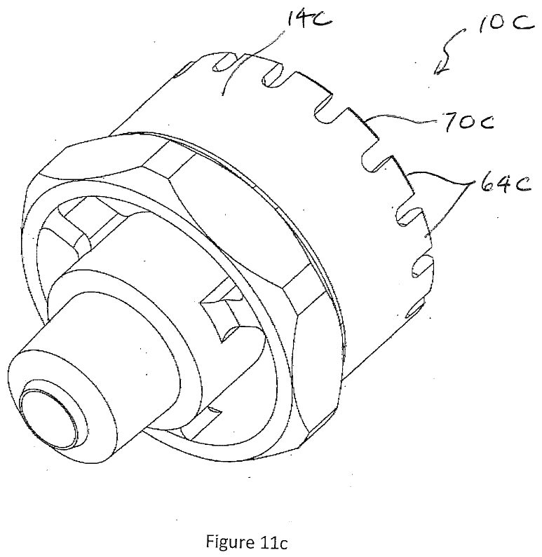

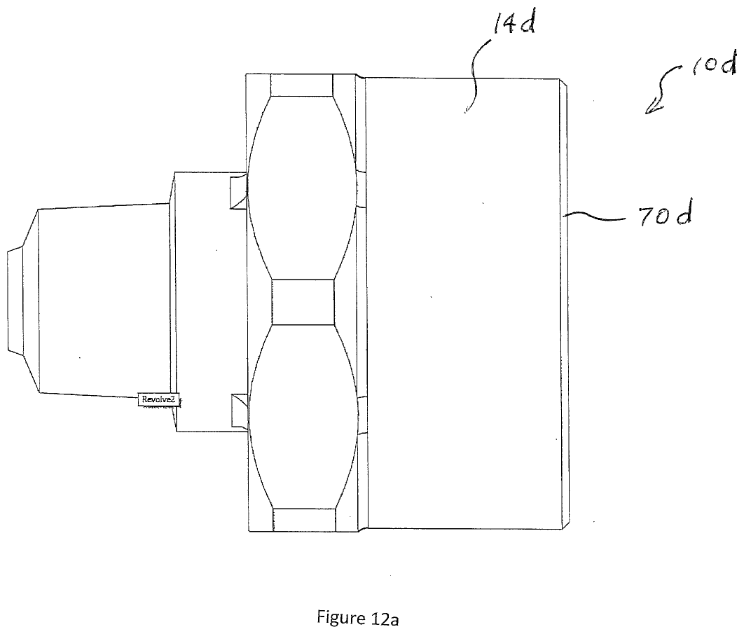

As illustrated in FIGS. 11a to 11c, in a yet further embodiment, aspirating spray nozzle 10c has a front end 70c. In this embodiment, the shroud 14c is substantially cylindrically-shaped without tapering. Referring to FIGS. 12a to 12c, in a yet further embodiment, aspirating spray nozzle 10d has a front end 70d. In this embodiment, the front end 70d of the shroud 14d has no teeth.

In operation, the aspirating spray nozzle 10 of the present invention is designed to concurrently deliver the following:

1. it acts as a uniquely short range foam projecting device adapted to generate a medium or wide angle spray pattern or plume and disperse a foaming solution in an optimized density and coverage at a specific short distance. Such a nozzle is generally referred to as a full cone nozzle. Note that foaming nozzles typically function as long range dispersion devices operating at a safer distance from the fire;
2. it functions to assist in a first stage of mixing and aspirating via turbulent agitation and aeration of a liquid and surfactant foaming solution, which is achieved by the “mixing swirl” inside the nozzle 10 for generating a cavitation effect as a result of the full cone nozzle core;
3. it functions to facilitate a second stage mixing and aspirating via Venturi shroud aeration without impeding the desired pattern of dispersion;
4. It functions to facilitate a third stage mixing and aspirating via a plume interaction with the outer radial periphery of the shroud 14, the interaction being controlled by the teeth 64a (ie. the degree of castellation) about the exit from none to multiple of varying depths;
5. it accommodates an orifice protection device which preferably is in a foil style
6. it is extremely compact in order to function in the unique environment and circumstances as described above; and
7. it is in one piece possessing the desired strength and torque resistance so as to facilitate the spray nozzle 10 being screwed on and off easily via a simple tool without causing any damage to the outer shroud.

Now that preferred embodiments of the present invention have been described in some detail, it will be apparent to a skilled person in the art that the aspirating spray nozzle of the present invention may offer at least the following advantages:
1. it is compact;
2. it allows easy frontal access and tool engagement for attachment or removal of the spray nozzle;
3. it enables installation of the spray nozzle into areas otherwise unreachable;
4. it is able to incorporate the foil membrane technology;
5. it facilitates maximized airflow thereby enhancing the Venturi effect;
   6. it enables the generation of a full conical spray plume (as opposed to the conventional solid stream jet);
7. it offers a high structural integrity thereby enabling the shroud to sustain a high torsional force.

Those skilled in the art will appreciate that the invention described herein is susceptible to variations and modifications other than those specifically described. For instance, the number, size and configuration of the shrouds and vents may be altered. Also, the exterior periphery of the base 28 of the shroud may take different forms and shapes so long as it enables tool engagement for effecting rotation of the spray nozzle. All such variations and modifications are to be considered within the scope and spirit of the present invention the nature of which is to be determined from the foregoing description.

1-18. (canceled)

19. An aspirating spray nozzle including:
a cylindrical nozzle body having an externally threaded first end portion defining an inlet, a second end portion defining an outlet, and a middle portion;
an integrated annular shroud having a tapering external wall which encircles at least part of the nozzle body and a base which is integrally joined to the middle portion by way of webbing means; and
a nozzle cap adapted to be connected to the second end portion of the nozzle body.

20. The aspirating spray nozzle of claim 19, wherein the base includes an exterior periphery so shaped and configured as to facilitate manual or tool based engagement with the exterior periphery for turning of the rotatable spray nozzle.

21. The aspirating spray nozzle of claim 20, wherein the exterior periphery includes one or more flats which enable the shroud to be driven to rotate by a tool such as a wrench or spanner.

22. The aspirating spray nozzle of claim 20, wherein the exterior periphery is a hex which gives a good granularity of angles for the tool to approach from.

23. The aspirating spray nozzle of claim 19, wherein the webbing means include spokes, each spoke of the spokes having one end integrally connected to an interior of the base of the shroud and an opposite end to the middle portion of the nozzle body.

24. The aspirating spray nozzle of claim 23, wherein the spokes are evenly spaced apart around the middle portion which is cylindrical.

25. The aspirating spray nozzle of claim 23, wherein a side wall of each spoke of the spokes partially defines a vent being arc-shaped visible from a rear end of the spray nozzle.

26. The aspirating spray nozzle of claim 25, wherein the side wall has a flat elongate middle section flanked by radiused ends which merge with an interior of the base of the shroud and an exterior of the middle portion of the nozzle body, respectively.

27. The aspirating spray nozzle of claim 24, wherein three spokes of the spokes are provided in between the base of the shroud and the middle portion of the nozzle body thereby creating three vents around the nozzle body.

28. The aspirating spray nozzle of claim 23, wherein each spoke of the spokes is disposed slantingly with respect to a plane defined by the base of the shroud so as to maximise aerodynamics thereby generating a maximised Venturi effect when in use.

29. The aspirating spray nozzle of claim 23, wherein each spoke of the spokes has a cross section with a moderate width and a relatively long axial length.

30. The aspirating spray nozzle of claim 19, wherein the shroud is substantially frustoconically-shaped.

31. The aspirating spray nozzle of claim 19, wherein the shroud is substantially cylindrically-shaped.

32. The aspirating spray nozzle of claim 19, wherein the first externally threaded first end portion is threadably connected to a wall, a manifold, a pipe or another fitting.

33. The aspirating spray nozzle of claim 19, wherein the shroud has a front end.

34. The aspirating spray nozzle of claim 33, wherein the front end includes teeth with a chosen depth.

35. The aspirating spray nozzle of claim 34, wherein the teeth vary in depth.

36. The aspirating spray nozzle of claim 19, wherein a front end of the shroud has no teeth.
